(19) United States
(12) Patent Application Publication
(10) Pub. No.: US 2006/0101216 A1
(43) Pub. Date: May 11, 2006

(54) Disk array apparatus, method of data recovery, and computer product

(75) Inventors: Akihito Kobayashi, Kawasaki (JP); Katsuhiko Nagashima, Kawasaki (JP); Koji Uchida, Kawasaki (JP); Fumiaki Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/067,329

(22) Filed: Feb. 28, 2005

(30) Foreign Application Priority Data
Nov. 8, 2004 (JP) 2004-323719

(51) Int. Cl. G06F 12/00; G06F 12/16

(52) U.S. Cl. 711/162; 714/2; 711/143

(57) ABSTRACT

A primary disk and a secondary disk that duplicates the data in the primary disk are connected to a host computer via a disk-array control unit. The disk-array control unit includes a plurality of central management units. Each central management unit includes a cache memory for writing data accessed, and a command-process executing unit that executes a process based on a command received. Each central management unit executes a process including determining, when there is an error in data stored in the primary disk while data stored in the secondary disk is normal, that a recovery process is necessary, duplicating, after completing an input/output process with the host computer, data written in the cache memory into a cache memory of any other central management unit, and writing-back the data written in the cache memory into the primary disk and the secondary disk.

### BACKGROUND OF THE INVENTION

1) Field of the Invention

The present invention relates to a disk array apparatus that includes a plurality of magnetic disk devices and a disk array controller that operates the magnetic disk devices in parallel to control reading and writing of data.

2) Description of the Related Art

A conventional disk array apparatus (redundant arrays of inexpensive disks: RAID) can access data massively stored in an external storage unit connected to a host computer in a high speed, with an improved reliability by providing a redundancy of the data at the time of an error occurrence (see, for example, Japanese Patent Application Raid-Open Publication No. 2004-164675). In general, the disk array apparatuses are classified into six levels, RAID0 to RAID5. In RAID1, same data is written in two magnetic disk devices. Therefore, even if one of the two magnetic disk devices fails, the data can be read from the other magnetic disk device, which improves the safety of the data.

The method of storing the same data in two or more magnetic disk devices is called mirroring of data and the structure that realizes the mirroring is called a mirror disk structure. The mirroring or the mirror disk structure can be realized in various ways. FIG. 7 is a schematic diagram of a conventional disk array apparatus 110 having the mirror disk structure. The disk array apparatus 110 is connected to a host computer 140 that is higher-level device. The disk array apparatus 110 includes six magnetic disk devices 121a to 121h that are hard disk devices, two channel adaptors 131a and 131b that are connected to the host computer 140, four central management units 132 that execute commands received from the host computer 140, four device adaptors 133a to 133d to which are connected the magnetic disk devices 121a to 121h. The disk array apparatus 110 can store data, and at the same time, can perform a mirroring of the data. The magnetic disk devices 121e to 121h store the same data that is in the magnetic disk devices 121a to 121d, respectively.

The disk array apparatus 110 includes four central management units 132a to 132d. Each central management unit controls a predetermined magnetic disk device from among the magnetic disk devices 121a to 121h. The central management unit 132a includes a command-process executing unit 151a, and a cache memory 152a that stores data. The cache memory 152a includes a local cache area 153a for storing data read from the predetermined magnetic disk device when reading data, and data to be written in the predetermined magnetic disk when writing data, and a mirror cache area 154a for duplicating the data to be written in the predetermined magnetic disk device. The other central management units 132b to 132d have the same structure as the central management unit 132a. The local cache areas of all the central management units are duplicated with the mirror cache areas in cyclic manner. For example, the local cache area 153a of the central management unit 132a is duplicated with a mirror cache area 154b of the neighboring central management unit 132b.

Following is an explanation of a write-back process in which data stored in a cache memory is written in a magnetic disk device. For example, a case in which data is written in the magnetic disk device 121a from the host computer 140 is explained. The channel adaptor 131a receives a write command to instruct writing of data from the host computer 140, and writes the data with check information indicating a validity of the data added in the local cache area 153a of the central management unit 132a that manages the magnetic disk device 121a that is the access destination specified in the write command. At the same time, the ““channel adaptors 131b receives the write command from the host computer 140, and writes the data with check information indicating a validity of the data added in the mirror cache area 154a of the central management unit 132b that manages the magnetic disk device 121e that duplicates the magnetic disk device 121a (hereinafter, “magnetic disk device for mirroring”). Thus, the same data is stored in the magnetic disk devices 121a and 121e.

Assume that the data in the local cache area 153a is corrupt data. In this case, because the same data is stored in the magnetic disk device 121a, it means that the data present in the magnetic disk device 121a is also corrupt data. Assume that normal data is stored in the mirror cache area 154b and the magnetic disk device 121e.

With these assumptions, when the host computer 140 executes a data read command to read the data written in the magnetic disk device 121a, the channel adaptor 131a delivers the data read command to the central management unit 132a that manages the magnetic disk device 121a to execute the data read command. At this moment, data is read from the local cache area 153a if corresponding data present in the local cache area 153a. On the other hand, if the corresponding data is not present in the local cache area 153a, the data is expanded into the local cache area 153a from the magnetic disk device 121a. The channel adaptor 131a performs an error check, and determines whether the data is normal data from check information in the data. Because it is assumed here that the data in the cache memory 152a is corrupt data, the channel adaptor 131a determines that the data is corrupt data. Because the data read is corrupt data, a process to read the same data from the magnetic disk device 121e is performed. The channel adaptor 131b delivers the data read command to the central management unit 132b to expand data into the local cache area 153b from the magnetic disk device 121e. After that, the channel adaptor 131b performs an error check for the data expanded into the local cache area 153b. In this example, because the data stored in the magnetic disk device 121e is normal, the channel adaptor 131b returns the data stored in the local cache area 153b of the cache memory 152b to the host computer 140. After that, the corrupt data in the magnetic disk device 121a is replaced with the normal data according to an instruction from a user of the host computer 140 or an administrator of the disk array apparatus 110.

As described above, in a conventional disk array apparatus, even if data becomes corrupt at the time of writing-back process, the corrupt data is written in the magnetic disk device. The corrupt data is not replaced with normal data until a user or an administrator notices that corrupt data is present in the magnetic disk device and instructs to overwrite normal data on the corrupt data. Therefore, if the fact that the corrupt data is present in the magnetic disk device passes unnoticed, the corrupt data is left in the magnetic disk device without being recovered.

### SUMMARY OF THE INVENTION

It is an object of the present invention to solve at least the problems in the conventional technology.

According to an aspect of the present invention, a disk array apparatus, the disk array apparatus being connected to an external device and stores data received from the external device in a data-writing operation and returns data to the external device in a data-reading operation based on a read command from the external device, includes a disk array unit including a first storage that stores data; and a second storage that duplicates the data that has been stored in the first storage; a plurality of central management units, each of which includes a cache memory having a local cache area to store data read from either of the first storage and the second storage when performing the data-reading operation, and to store data received from the external apparatus when performing the data-writing operation; and a mirror cache area that duplicate the data that has been stored in the local cache area during the data-writing operation; and a command-process executing unit that expands first data stored in the first storage into the local cache area upon receiving a read command for a first time, and expands second data from the second storage into the local cache area upon receiving the read command for a second time; a plurality of channel adapters, each of which includes a check-information adding unit that adds check information for an error check to data that is received from the external apparatus for storing in the first storage; an error checking unit that performs an error check for the data in the local cache area, based on the check information; and a recovery-process-execution determining unit that outputs a write-back instruction, when the error checking unit determines that the first data has an error while the second data is normal, to the command-process executing unit, after completion of an input/output process with the external apparatus. The command-process executing unit duplicates the second data stored in the local cache area into a mirror cache area of a cache memory of other central management unit, and upon the recovery-process-execution determining unit outputting the write-back instruction, performs a write-back operation, which is an operation for transferring the second data to the first storage and the second storage.

According to another aspect of the present invention, a data recovery method for a disk array apparatus that includes a first storage and a second storage for duplicating and storing data, a first cache unit that stores data at a time of accessing the first storage or the second storage, and a second cache unit that duplicates data stored in the first cache unit from outside, includes writing, when there is an error in first data written in the first cache unit from the first storage based on a data read command from an external apparatus connected to the disk array apparatus, second data in the first cache unit from the second storage based on data read command received again from the external apparatus; performing an error check for the second data; transmitting, when it is determined that the second data is normal based on the error check, the second data to the external apparatus; duplicating the second data written in the first cache unit into the second cache unit; and writing-back the second data written in the first cache unit and the second cache unit into the first storage and the second storage, respectively.

According to still another aspect of the present invention, a computer-readable recording medium stores therein a computer program that causes a computer to implement the above data recovery method.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a block diagram of a disk array apparatus according to an embodiment of the present invention;

FIG. 2 is a functional block diagram of a channel adaptor shown in FIG. 1;

FIG. 3 is an example of data structure;

FIG. 4 is a functional block diagram of a central management unit shown in FIG. 1;

FIG. 5 is a flowchart of a process procedure for a write-back of data;

FIG. 6A is a flowchart of a process procedure for data recovery, and FIG. 6B is a continuation of the flowchart shown in FIG. 6A; and

FIG. 7 is a block diagram of a conventional disk array apparatus.

### DETAILED DESCRIPTION

Exemplary embodiments of the present invention will be explained in detail below with reference to the accompanying drawings.

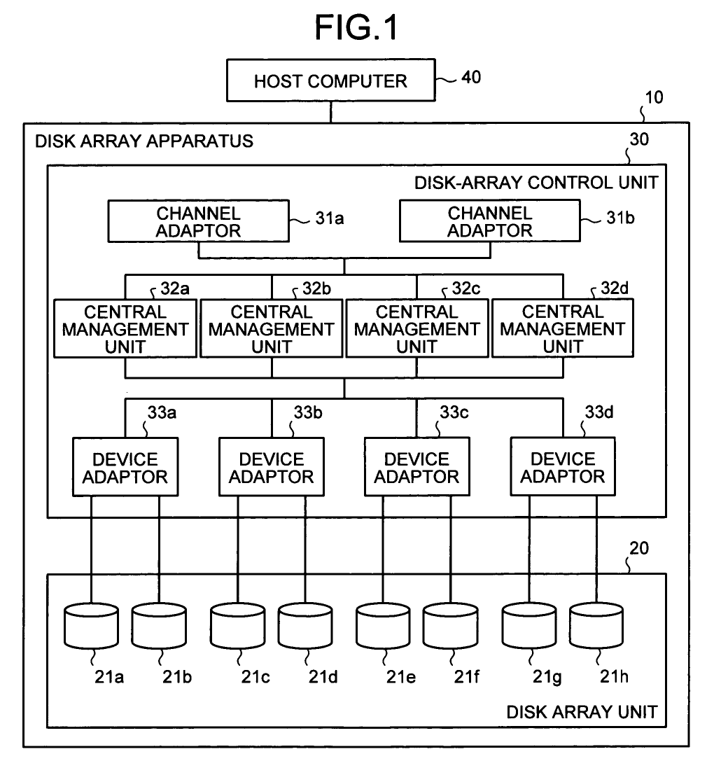

FIG. 1 is a block diagram of a disk array apparatus 10 according to an embodiment of the present invention. The disk array apparatus 10 is connected to a host computer 40 that is higher-level device and functions as an external storage apparatus for the host computer 40. A plurality of host computers can be connected to the disk array apparatus via a network or the like. The disk array apparatus 10 includes a disk array unit 20 that stores data, and a disk-array control unit 30 that controls the disk array unit 20.

The disk array unit 20 includes a plurality of magnetic disk devices (hard disk devices), and has a RAID1 structure or a RAID0+1 structure. The RAID1 structure typically has one magnetic disk device for storing data and one magnetic disk device for mirroring the data, to thereby providing a redundancy to the data. The RAID0+1 structure basically includes a RAID0 structure that distributes and stores data in n magnetic disk devices (where, n is a positive integer greater than 1), and includes n magnetic disk devices for mirroring, to provide a redundancy to the data. Regardless of the structure, a RAID system at least includes magnetic disk devices for storing data, and magnetic disk devices for duplicating the data. The magnetic disk devices that store data are sometimes referred to as primary disks and the magnetic disk devices that mirror the data as secondary disks. The secondary disks are also sometimes referred to as magnetic disk devices for mirroring because they mirror the data.

The disk array unit 20 includes, for example, eight magnetic disk devices (hard disk devices) 21a to 21h. The magnetic disk devices 21a to 21d are primary disks, and the magnetic disk devices 21e to 21h are secondary disks. The magnetic disk devices 21a to 21h include a logical unit (not shown) that is identified by the host computer 40. The number of magnetic disk devices is not limited to eight.

The disk-array control unit 30 includes a plurality of channel adaptors 31a and 31b that perform an interface control with respect to the host computer 40, the central management units 32a to 32d that control the disk array unit 20, and a plurality of device adaptors 33a to 33d that control the magnetic disk devices 21a to 21h. The numbers of the channel adaptors, the central management units, and the device adaptors, are not limited to two, four, and four, respectively.

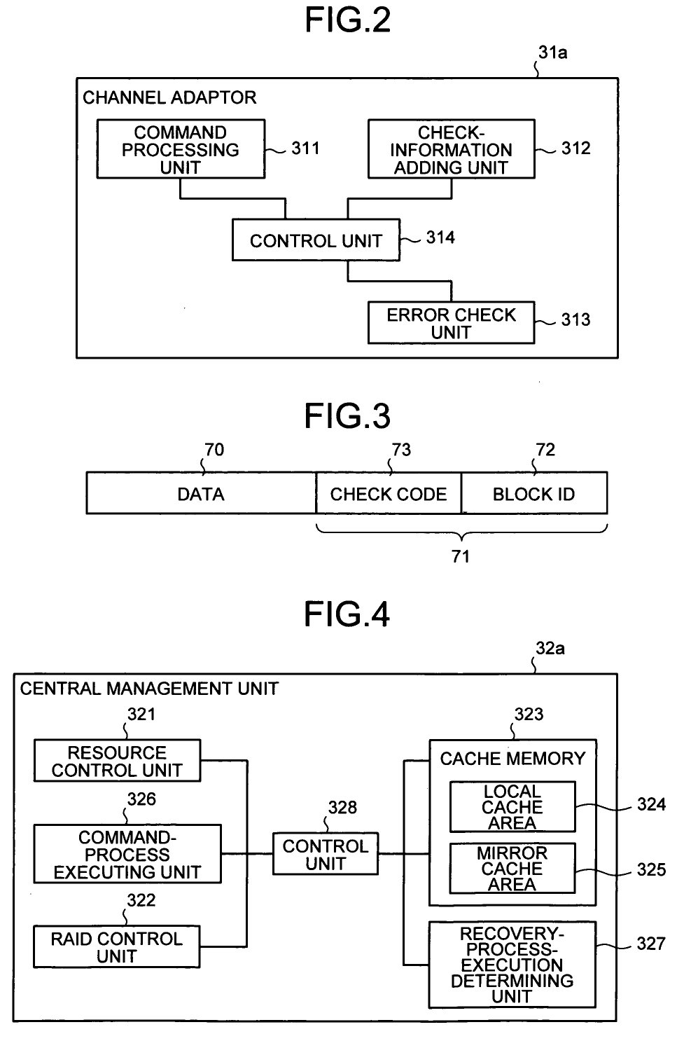

The channel adaptors 31a and 31b are interfaces with the host computer 40. FIG. 2 is an exemplary functional block diagram of the channel adaptor 31a. The channel adaptor 31b has similar configuration. The channel adaptor 31a includes a command processing unit 311 that processes a command from the host computer 40, a check-information adding unit 312 that creates check information for performing an error check for data to be written in the disk array apparatus 10 from the host computer 40, and adds the check information created to the data, an error checking unit 313 that performs an error check data accessed, and a control unit 314 that controls each of the processing units.

The command processing unit 311 has functions of delivering a command transmitted from the host computer 40 to a predetermined central management unit from among the central management units 32a to 32c, transmitting a result of execution of a command from the predetermined central management unit to the host computer 40, and notifying a result of execution of a command or a result of the error check to the predetermined central management unit. For example, when a plurality of central management units 32a to 32d is arranged, as shown in FIG. 1, each of the central management units 32a to 32d manages a predetermined magnetic disk device 21a to 21h, the command processing unit 311 identifies, based on an access destination of a command (such as a logical unit or a combination of a logical unit and a logical block address), a central management unit 32a to 32d to which the command is delivered, and delivers a command received to the central management unit identified.

Important information notified from the command processing unit 311 to the predetermined central management unit includes error notification information and process-complete notification information. The error notification information is information to notify the predetermined central management unit of an occurrence of an error when the error checking unit 313 determines that there is an error in data, and the process-complete notification information is information to notify the predetermined central management unit that a process with respect to the host computer 40 is completed immediately after returning a result of execution of a command to the host computer 40.

The check-information adding unit 312 has functions of creating check information to be used in determining whether there is an error in data when reading the data later for data to be written in the magnetic disk devices 21a to 21h from the host computer 40, and adding the check information created to the data. As for the error check, for example, a cyclic redundancy check (CRC) can be used.

FIG. 3 is a schematic of data to which the check information is added. The check information 71 includes a block ID 72, and a check code 73, and is added to data 70 to be written in the disk array apparatus 10. The block ID 72 is logical location and property information of the data, the check code 73 is an error correction code for checking a validity of the data. For example, the check code 73 is created per a block of a predetermined data size, and added to the data 70 as the check information 71. The check code 73 when using the CRC is a residue obtained by assuming data as a polynomial, and dividing the polynomial by a generator polynomial.

The error checking unit 313 performs, when transmitting data to be stored in the disk array units 20a to 20h or a cache memory 323 to the host computer 40, an error checking for the data whether the data 70 to transmit is normal, using the check information 71 added to the data 70. A method of the error check includes creating a code for the data 70 in a similar manner to the creation of the check information 71 by the check-information adding unit 312, and comparing the data actually calculated with the check code 73 included in the check information 71 added to the data 70 to detect an error in the data.

FIG. 4 is an exemplary functional block diagram of the central management unit 32a. The central management units 32b to 32d have the same configuration. The central management unit 32a includes a resource control unit 321 that performs a management of a resource, a RAID control unit 322 that controls input/output (I/O) of the magnetic disk devices 21a to 21h in each of the RAID levels, a cache memory 323 that temporarily stores data, a command-process executing unit 326 that performs a process of a command received, and a control of the cache memory 323, a recovery-process-execution determining unit 327 that determines whether a recovery process is necessary because of a presence of data having an error in the magnetic disk devices 21a to 21h, and a control unit 328 that controls each of the processing units. When a plurality of central processing units 32a to 32d is arranged, as shown in FIG. 1, a range of a logical unit formed with the magnetic disk devices 21a to 21h that is controlled by each of the central processing units 32a to 32d is determined in advance.

The resource control unit 321 has an area excluding function for limiting, when the host computers are connected in plurality, the host computer that can perform a modification of data at a time when other host computer has accessed the same data, and a resource control function for controlling an I/O-related process in each of the processing units.

The RAID control unit 322 has functions of converting a physical magnetic disk device 21a to 21h into a level of a logical unit, and performing a control of an I/O of the magnetic disk device 21a to 21h in each of the RAID levels, such as a mirroring, or a control or a management of a stripe per each of the RAID levels.

The cache memory 323 is a temporary storage unit that stores data accessed from the host computer 40 or data to be written in the magnetic disk devices 21a to 21h, including a local cache area 324 to temporarily store data to be written in the disk array unit 20 from the host computer 40 or data read from the disk array unit 20, and a mirror cache area 325 to temporarily store data for duplicating (mirroring) data to be written when writing data in the disk array unit 20. Furthermore, in a mirror cache area of a central management unit 32, not only data stored in the local cache are 324 of the same cache memory 323 is duplicated, but also data stored in a local cache area of a cache memory 323 of other neighboring central management unit from among the central management units 32a to 32d is duplicated. As a result, the local cache area 324 and the mirror cache area 325 of all the central management units 32a to 32d are duplicated in a cyclic manner.

In the example shown in FIG. 1, the data written in the cache memory 323 of the central management unit 32a from the host computer 40 is duplicated in the mirror cache area 325 of the cache memory 323 of the central management unit 32b. Similarly, the local cache area 324 of the central management unit 32b is duplicated in the mirror cache area 325 of the central management unit 32c, the local cache area 324 of the central management unit 32c is duplicated in the mirror cache area 325 of the central management unit 32d, and the local cache area 324 of the central management unit 32d is duplicated in the mirror cache area 325 of the central management unit 32a.

The command-process executing unit 326 has functions of managing and controlling the cache memory 323 used for the I/O, and performing a process of a command received. For example, when the command-process executing unit 326 received a request for reading data from the command processing unit 311 of the channel adaptor 31a or 31b, the command-process executing unit 326 determines a cache hit/cache miss of the cache memory 323 with respect to the I/O. In a case of the cache hit, the command-process executing unit 326 prepares data stored in the local cache area 324 of the cache memory 323, and in a case of the cache miss, prepares data by performing a stage operation of expanding data from the magnetic disk devices 21a to 21h into the local cache are 324 of the cache memory 323. Similarly, when the command-process executing unit 326 received a request for writing data, the command-process executing unit 326 duplicates data written in the local cache area 324 of the cache memory 323 into the mirror cache area 325, and writes the data in the primary disk and the secondary disk, respectively. Furthermore, when the cache memory 323 is depleted, the command-process executing unit 326 performs a write-back process to write back corrupt data stored in the local cache area 324 of the cache memory 323 into the magnetic disk devices 21a to 21h, or a scheduling, such as a process to flush data from the cache memory 323.

The recovery-process-execution determining unit 327 determines whether certain data accessed by the host computer 40 is corrupt data indicating that data stored in the local cache area 324 of the cache memory 323 and data stored in the primary disk do not match, and when it is determined to be corrupt data, instructs the command-process executing unit 326 to execute a write-back process to write back data stored in the local cache area 324 into the disk array unit 20. When there is an error in data read from the magnetic disk device 21a to 21d as the primary disk, and when data read from the magnetic disk device 21e to 21h as the secondary disk is normal, the recovery-process-execution determining unit 327 determines that it is necessary to execute a recovery process, and makes the command-process executing unit 326 execute a process to write back the normal data into the disk array unit 20 after completing the I/O with the host computer 40.

The determination is made using the error notification information received firstly from the command processing unit 311 of the channel adaptors 31a and 31b when data read from the primary disk has an error, and the process-complete notification information received later from the command processing unit 311 of the channel adaptors 31a and 31b when data read from the secondary disk is normal. In other words, only when the process-complete notification information is received after the error notification information has received with respect to certain data, the recovery-process-execution determining unit 327 instructs an execution of a recovery process for the magnetic disk device 21a to 21h. With this recovery process, a discrepancy between data stored in the cache memory 323 and data stored in the primary disk, which is stored in the same location as that of the data stored in the cache memory 323, is dissolved, and a non-corrupt status is maintained.

The device adaptors 33a and 33b have a function of exchanging commands or data between the central management units 32a to 32d and the magnetic disk devices 21a to 21h, to control the magnetic disk devices 21a to 21h based on an instruction from the central management units 32a to 32d.

The disk array apparatus 10 is an external storage apparatus for the host computer 40, to which necessary data is written by a write command from the host computer 40. Furthermore, the disk array apparatus 10 performs a process to write back data stored in the cache memory 323 into corresponding magnetic disk device 21a to 21h (a write-back process) after writing data in the local cache area 324 and the mirror cache area 325 of the cache memory 323 by the write command from the host computer 40. After that, a variety of commands from the host computer 40, such as a read command, is executed. Following is explanations of (1) a write-back process of data, and (2) a recovery process of the disk array apparatus 10 when data accessed to be written in the primary disk has an error and data stored in the secondary disk is normal.

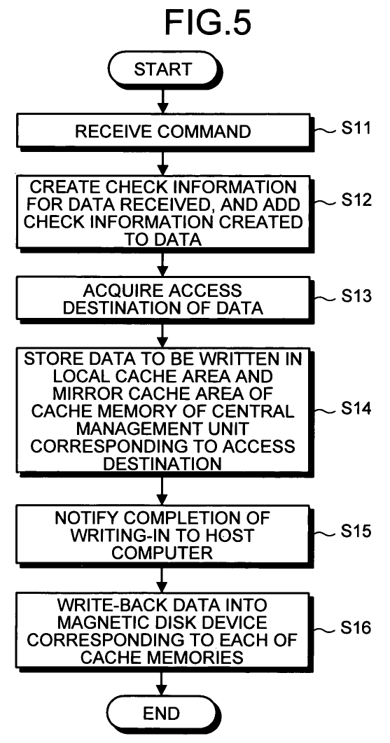

FIG. 5 is a flowchart of a process procedure for a write-back of data. In this example, data is written back into the magnetic disk devices 21a and 21e shown in FIG. 1, and the central management unit 32a manages the magnetic disk devices 21a and 21e. As described above, the local cache area 324 of the central management unit 32a is duplicated with the mirror cache area 325 of the central management unit 32b. First of all, when the channel adaptor 31a receives a data write command from the host computer 40 (step S11), the check-information adding unit 312 of the channel adaptor 31a creates check information for data received, and adds the check information created to the data (step S12). The command processing unit 311 of the channel adaptor 31a acquires an access destination for the data (such as a logical unit number and a logical block address) (step S13), and selects the central management unit 32a that manages the magnetic disk device 21a corresponding to the access destination.

The command processing unit 311 of the channel adaptor 31a stores the data to which the check information is added in the local cache area 324 of the cache memory 323 of the central management unit 32a selected, and the mirror cache area 325 of a cache memory 323 of other central management unit from among the central management units 32b to 32d for duplicating the data (step S14). Subsequently, the command processing unit 311 of the channel adaptor 31a notifies the host computer 40 of completion of writing data (step S15), the command-process executing unit 326 of the central management unit 32a writes back the data stored in the local cache area 324 of the cache memory 323 of its own into the primary disk (magnetic disk device 21a), and a command-process executing unit 326 of the other central management unit 32b writes back the data stored in the local cache area 324 of the cache memory 323 of its own into the secondary disk (magnetic disk device 21e) (step S16). With this mechanism, a write-back process of data is completed.

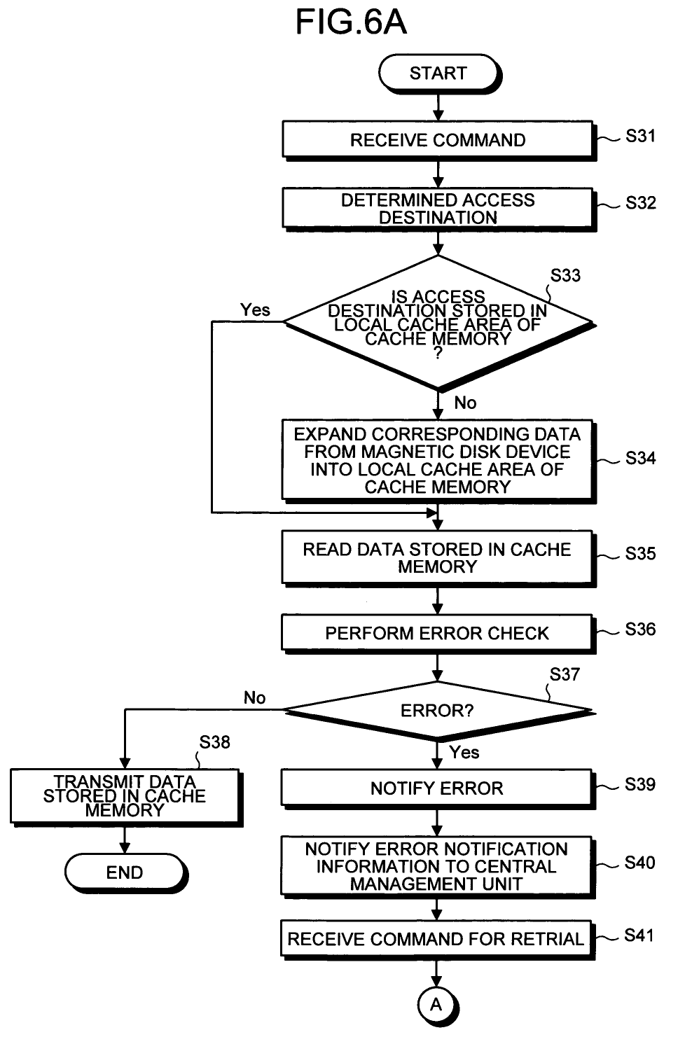

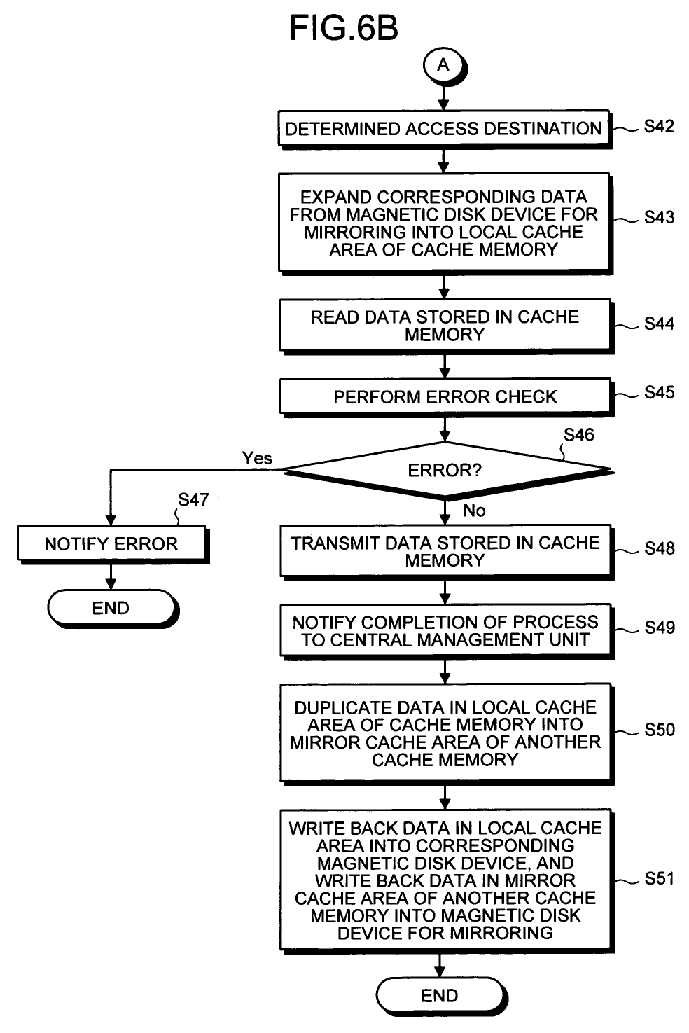

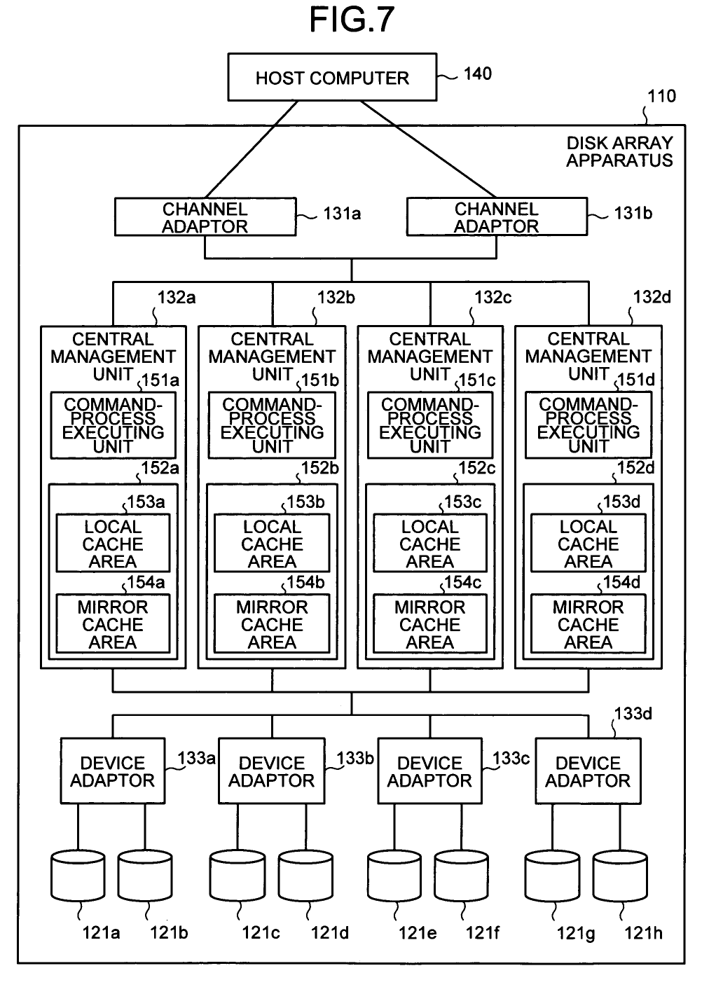

FIGS. 6A and 6B are flowcharts of a process procedure for data recovery when there is an error in data stored in the primary disk firstly access, and when data stored in the secondary disk is normal. In this example, a process is to read data stored in the magnetic disk devices 21a and 21e by the procedures described in FIG. 5. It is assumed that data stored in the magnetic disk device 21a as the primary disk has an error, and data stored in the magnetic disk device 21e as the secondary disk is normal. First of all, the channel adaptor 31a receives a read command from the host computer 40 (step S31), and determines an access destination for data (step S32). In other words, the channel adaptor 31a selects the central management unit 32a that manages the magnetic disk device 21a of the access destination based on access destination information indicating a location of the access destination, such as logical unit or a logical block address, included in the command, and notifies the command received to the central management unit 32a.

The command-process executing unit 326 of the central management unit 32a determines whether data of the access destination is stored in the local cache area 324 of the cache memory 323 (step S33). When the data is not stored in the local cache area 324 (“NO” at step S33), the command-process executing unit 326 makes a request to the device adaptor 33a for performing a staging process to expand corresponding data from the primary disk (magnetic disk device 21a) into the local cache area 324 of the cache memory 323. Following this request, the device adaptor 33a reads the corresponding data from the primary disk, and expands the data read into the local cache area 324 of the cache memory 323 (step S34). After that, or when the data of the access destination is stored in the local cache area 324 at the Step S33 (“YES” at step S33), the command processing unit 311 of the channel adaptor 31a reads data corresponding to the access destination from the local cache area 324 (step S35).

The error checking unit 313 of the channel adaptor 31a performs an error check for the data read using a predetermined method (step S36). When there is no error (“NO” at step S37), the command processing unit 311 of the channel adaptor 31a transmits the data stored in the local cache area 324 to the host computer 40 (step S38), and a process for the read command is completed. On the other hand, when there is an error detected (“YES” at step S37), the command processing unit 311 of the channel adaptor 31a notifies the host computer 40 of the error (step S39), and notifies the error notification information to the central management unit 32a (step S40). Upon receiving a notification of the error, the host computer 40 retries the read command. The recovery-process-execution determining unit 327 of the central management unit 32a stores the error notification information together with the command that is a source of the error notification information.

The channel adaptor 31a of the disk array apparatus 10 receives a read command for a retry (step S41), and determines an access destination in the same manner as described in the step32 (step S42). Namely, the channel adaptor 31a selects the central management unit 32a that manages the magnetic disk device 21e of the access destination based on access destination information indicating a location of the access destination, such as logical unit or a logical block address, included in the command, and delivers the command received to the central management unit 32a. At this moment, because the command is a retry of the previous command, the command-process executing unit of the central management unit 32a expands required data from the secondary disk (magnetic disk device 21e for mirroring) into the local cache area 324 of the cache memory 323 (step S43).

After that, the command processing unit 311 of the channel adaptor 31a reads data corresponding to the access destination from the local cache area 324 of the cache memory 323 (step S44), and the error checking unit 313 performs an error check for the data read (step S45). When there is an error (“YES” at step S46), the command processing unit 311 notifies the host computer of the error (step S47), and the recovery process is finished because another recovery process cannot be performed in this case. On the other hand, when there is no error (“NO” at step S46), the command processing unit 311 transmits the data stored in the local cache area 324 to the host computer 40 (step S48), and notifies the central management unit 32a of the process-complete notification information indicating that a process with respect to the host computer 40 is completed (step S49).

Upon receiving the process-complete notification information, the recovery-process-execution determining unit 327 of the central management unit 32a recognizes that there is a discrepancy between the data stored in the local cache area 324 of the cache memory 323 and the corresponding data stored in the primary disk (magnetic disk device 21a), because the error notification information has been received at the step S40, and the process-complete notification information has been received at the step S49, and notifies the command-process executing unit 326 to execute a write-back process. The command-process executing unit 326 duplicates the data stored in the local cache area 324 of the cache memory 323 of the central management unit 32a into the mirror cache area 325 of the cache memory 323 of the central management unit 32b (step S50), and writes back the data stored in the local cache area 324 into the primary disk (magnetic disk device 21a) in which the data having an error is stored (step S51). At the same time, the command-process executing unit 326 of the central management unit 32b writes back the data stored in the mirror cache area 325 of the cache memory 323 of its own into the secondary disk (magnetic disk device 21d for mirroring). With this, a process to write back normal data into the cache memory 323 in which data having an error is stored the magnetic disk device 21a corresponding to the cache memory 323 is completed.

According to the present embodiment, an example in which a cache memory and a magnetic disk device are duplicated is explained, however, it is also possible to apply in same manner to a system having three or more cache memories and magnetic disk devices for a multiple duplication.

The above method of issuing a command from a target side to an initiator side can be implemented by storing a computer program including a process procedure for the method in a computer-readable recording medium, and reading and executing the computer program by an operation processing unit having a function of processing the computer program in a disk array apparatus. The computer-readable recording medium includes, for example, a portable recording medium, such as a flexible disk, a compact disk-read only memory (CD-ROM), an optical-magnetic disk, a digital versatile disk (DVD), and an integrated-circuit (IC) card, a fixed recording medium, such as an internal hard disk drive or an external hard disk drive of a computer, a random access memory (RAM), and a read only memory (ROM), and a communication medium that temporarily stores the computer program when transmitting the computer program, such as a public line connected via a modem, and local area network (LAN)/wide area network (WAN).

As described above, according to the present embodiment, the channel adaptor 31a performs an error check for data before returning the data required from the host computer 40. When there is an error in the data stored in the primary disk, error notification information is transmitted to the central management unit 32a, and when corresponding data stored in the secondary disk is normal, a process-complete notification information indicating completion of a process for a command from the host computer 40 is transmitted to the central management unit 32. The central management unit 32a determines whether a recovery process is necessary for data having an error stored in the disk array unit 20 based on the error notification information and the process-complete notification information, and when receiving the process-complete notification information after having received the error notification information, executes the recovery process at a time of retry, using data written in the cache memory 323.

With this mechanism, when the disk array apparatus 10 has data having an error, it is possible to automatically perform a recovery process for the data at an extension of an input/output to the disk array apparatus 10. In the recovery process, because data written in the cache memory 323 from the magnetic disk devices for mirroring 21e to 21h, which are the secondary disks, is used, it is possible to effectively use steps and resources required for the recovery process, compared with a case in which the recovery process is performed later. Furthermore, when disk array apparatus 10 recognizes that data having an error exists, a recovery process is immediately executed, and as a result, the disk array apparatus 10 can always maintain a status in which normal data is stored. Moreover, it is possible to prevent a status in which data having an error is left in the disk array apparatus 10 for a long time as it is, without being recognized by a user or an administrator of the disk array apparatus 10.

According to the present invention, when corrupt data is detected at the time of accessing data stored in a disk array apparatus from an external apparatus, the corrupt data is recovered to normal data after completing the access to the data. Thus, a user or an administrator need do not have to recognize that there is corrupt data in the disk array apparatus. As a result, it is possible to reduce work-load on the user or the administrator. Furthermore, because the corrupt data is found at the time of accessing the data, the corrupt data can be recovered almost instantaneously. Moreover, because normal data expanded into a local cache area at the time of accessing the data is used when performing a recovery, it is possible to effectively use resources in the recovery of data. For example, if the user or the administrator performs the recovery process, it is necessary to expand the data into the cache memory again. However, according to the present invention, it is possible to minimize number of works in the recovery process, because the data expanded into the cache memory at the time of access. Besides, it is also possible to prevent from leaving data having an error for a long time as it is.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A disk array apparatus, the disk array apparatus being connected to an external device and stores data received from the external device in a data-writing operation and returns data to the external device in a data-reading operation based on a read command from the external device, comprising:
a disk array unit including
a first storage that stores data; and
a second storage that duplicates the data that has been stored in the first storage;
a plurality of central management units, each of which includes
a cache memory having
a local cache area to store data read from either of the first storage and the second storage when performing the data-reading operation, and to store data received from the external apparatus when performing the data-writing operation; and
a mirror cache area that duplicate the data that has been stored in the local cache area during the data-writing operation; and
a command-process executing unit that expands first data stored in the first storage into the local cache area upon receiving a read command for a first time, and expands second data from the second storage into the local cache area upon receiving the read command for a second time;
a plurality of channel adapters, each of which includes
a check-information adding unit that adds check information for an error check to data that is received from the external apparatus for storing in the first storage;
an error checking unit that performs an error check for the data in the local cache area, based on the check information; and
a recovery-process-execution determining unit that outputs a write-back instruction, when the error checking unit determines that the first data has an error while the second data is normal, to the command-process executing unit, after completion of an input/output process with the external apparatus, wherein
the command-process executing unit duplicates the second data stored in the local cache area into a mirror cache area of a cache memory of other central management unit, and upon the recovery-process-execution determining unit outputting the write-back instruction, performs a write-back operation, which is an operation for transferring the second data to the first storage and the second storage.

2. The disk array apparatus according to claim 1, wherein the first storage and the second storages are magnetic disks.

3. The disk array apparatus according to claim 1, wherein the disk array unit has a RAID1 structure.

4. The disk array apparatus according to claim 1, wherein the disk array unit has a RAID0+1 structure.

5. A data recovery method for a disk array apparatus that includes a first storage and a second storage for duplicating and storing data, a first cache unit that stores data at a time of accessing the first storage or the second storage, and a second cache unit that duplicates data stored in the first cache unit from outside, the data recovery method comprising:
writing, when there is an error in first data written in the first cache unit from the first storage based on a data read command from an external apparatus connected to the disk array apparatus, second data in the first cache unit from the second storage based on data read command received again from the external apparatus;
performing an error check for the second data;
transmitting, when it is determined that the second data is normal based on the error check, the second data to the external apparatus;
duplicating the second data written in the first cache unit into the second cache unit; and
writing-back the second data written in the first cache unit and the second cache unit into the first storage and the second storage, respectively.

6. The data recovery method according to claim 5, wherein the first storage and the second storages are magnetic disks.

7. A computer-readable recording medium that stores therein a computer program that causes a computer to implement a data recovery method for a disk array apparatus that includes a first storage and a second storage for duplicating and storing data, a first cache unit that stores data at a time of accessing the first storage or the second storage, a second cache unit that duplicates data stored in the first cache unit from outside, and a disk-array control unit that controls a process of reading or writing data, the computer program causing the computer to execute:
receiving a data read command from an external apparatus connected to the disk array apparatus;
writing, when there is an error in first data, which is written in the first cache unit from the first storage, corresponding to the data read command, second data corresponding to the data read command in the first cache unit from the second storage;
performing an error check for the second data written in the first cache unit from the second storage;
transmitting, when it is determined that the second data is normal based on the error check, the second data to the external apparatus;
duplicating the second data written in the first cache unit into the second cache unit; and
writing-back the second data written in the first cache unit and the second cache unit into the first storage and the second storage, respectively.

8. The computer-readable recording medium according to claim 7, wherein the first storage and the second storages are magnetic disks.
